(19) United States
(12) Patent Application Publication
(10) Pub. No.: US 2016/0088457 A1
(43) Pub. Date: Mar. 24, 2016

(54) INFORMATION PROCESSING APPARATUS, COMMUNICATION APPARATUS, TERMINAL, COMMUNICATION PROCESSING METHOD AND NON-TRANSITORY COMPUTER READABLE MEDIUM

(71) Applicant: KABUSHIKI KAISHA TOSHIBA, Tokyo (JP)

(72) Inventors: Yuichiro OYAMA, Tokyo (JP); Takeshi ISHIHARA, Yokohama (JP); Hiroshi NISHIMOTO, Yokohama (JP)

(21) Appl. No.: 14/855,639

(22) Filed: Sep. 16, 2015

(30) Foreign Application Priority Data
Sep. 18, 2014 (JP) 2014-190433

(51) Int. Cl. H04W 8/00; H04W 76/02

(52) U.S. Cl. CPC H04W 8/005; H04W 76/02

(57) ABSTRACT

According to one embodiment, an information processing apparatus includes an execution controller. The execution controller acquires a communication request for requesting data communication with another communication apparatus and controls execution of the communication request by comparing an evaluation value with a threshold, the evaluation value being based on a parameter value obtained through measurement of a wireless communication environment. The execution controller changes the threshold so as to decrease or increase according to a lapse of time after acquiring the communication request.

### CROSS-REFERENCE TO RELATED APPLICATIONS

This application is based upon and claims the benefit of priority from Japanese Patent Application No. 2014-190433, filed Sep. 18, 2014; the entire contents of which are incorporated herein by reference.

### FIELD

Embodiments described herein relate to an information processing apparatus, a communication apparatus, a terminal, a communication processing method and a non-transitory computer readable medium.

### BACKGROUND

A technology exists to execute a communication request when the communication request is determined to be executable by determining whether or not the communication request (for example, a data transmission request) which is issued by an application and temporarily stored is executable. It is performed for determining whether or not the communication request is executable by, for example, calculating an evaluation value of a radio wave environment from received signal strength, a nose signal level, or the like, of a signal received from a wireless LAN access point, or the like, and comparing the evaluation value with a fixed threshold. If the evaluation value exceeds the threshold, it is determined that the communication request is executable. If the evaluation value does not exceed the threshold, or if no threshold exceeded access point can be found, there is a possibility that execution of the communication request may not be completed indefinitely.

### BRIEF DESCRIPTION OF THE DRAWINGS

FIG. 1 is a block diagram of a communication apparatus provided with an information processing apparatus according to a first embodiment of the present invention;

FIG. 2 is a diagram illustrating a first example of a method of changing a threshold according to the first embodiment;

FIG. 3 is a diagram illustrating a second example of the method of changing the threshold according to the first embodiment;

FIG. 4 is an operation sequence diagram of a first phase according to the first embodiment;

FIG. 5 is an operation sequence diagram of a second phase according to the first embodiment;

FIG. 6 is a flowchart of operation of comparing an evaluation value with a threshold;

FIG. 7 is a flowchart of processing of changing the threshold;

FIG. 8 is an operation sequence diagram of a third phase according to the first embodiment;

FIG. 9 is a flowchart of operation according to a second embodiment;

FIG. 10 is a block diagram of a communication apparatus provided with an information processing apparatus according to a third embodiment; and

FIG. 11 is a block diagram of a terminal provided with an information processing apparatus according to a fourth embodiment.

### DETAILED DESCRIPTION

Embodiments of the present invention will be described below with reference to the drawings. Embodiments described here is an example, and implementation of the present invention is not necessarily limited to the embodiments described here. Further, the same reference numerals are assigned to the same components in the drawings, and overlapped explanation will be omitted as appropriate except processing which is modified or expanded.

### First Embodiment

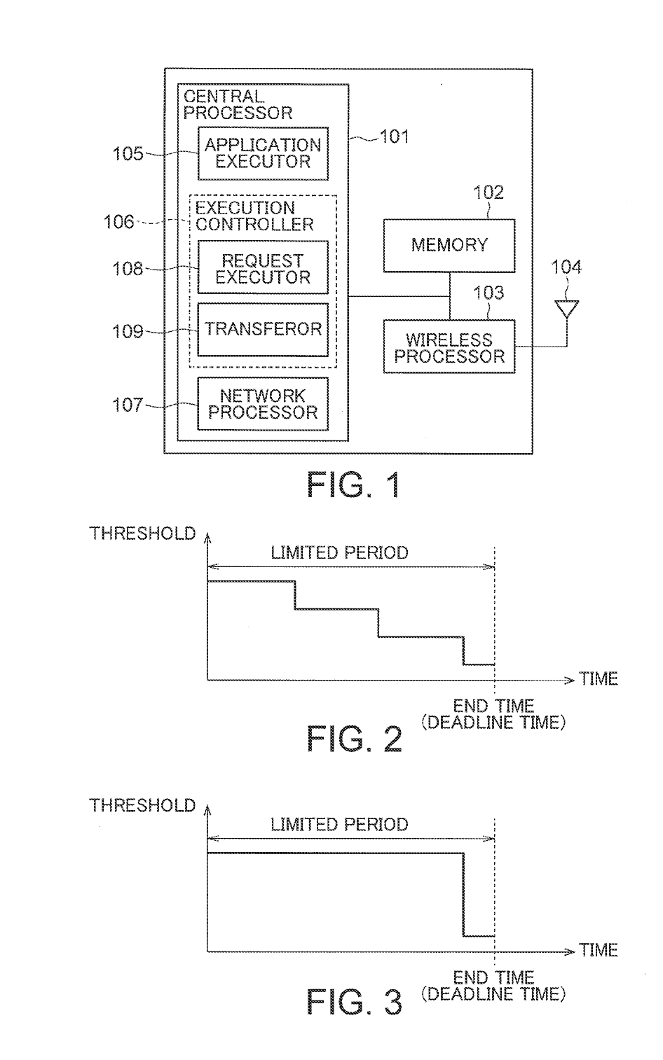

FIG. 1 is a block diagram of a communication apparatus provided with an information processing apparatus according to a first embodiment. It should be noted that while FIG. 1 illustrates only components necessary for describing the embodiment, this illustration does not exclude other components.

The communication apparatus of FIG. 1 is connected to a base station (such as a base station of cellular communication and a wireless LAN access point) via a wireless network complying with a predetermined communication standard. The communication apparatus communicates with another communication apparatus which becomes final destination according to a communication protocol such as TCP/IP via the base station. At this time, the base station which also operates as a relay apparatus, becomes direct communication destination of the communication apparatus. Of course, the base station itself may be another communication apparatus which is the final destination. It is also possible to employ a configuration where the communication apparatus directly communicates with another communication apparatus using an ad hoc mode of wireless LAN without involving the base station.

The communication apparatus includes a central processor 101, a memory 102, a wireless processor 103 and an antenna 104. The central processor 101, the memory 102 and the wireless processor 103 are connected via a bus. The antenna 104 is connected to the wireless processor 103. The central processor 101 corresponds to the information processing apparatus according to the present embodiment.

The central processor 101 (information processing apparatus) includes an application executor 105, an execution controller 106, and a network processor 107. The execution controller 106 includes a transferor 109 and a request executor 108. The application executor 105, the transferor 109, the request executor 108 and the network processor 107 may be configured as hardware components, or each function may be implemented with software, and realized by a processor such as a CPU. Further, the application executor 105, the transferor 109, the request executor 108 and the network processor 107 may be configured as hardware components which are independent from each other. The communication apparatus may be implemented with a single integrated circuit, or may be implemented with a plurality of separate integrated circuits. The central processor 101 and the wireless processor 103 can be implemented by circuitry such as a processor or an integrated circuit. Each circuitry which implements the central processor 101 and the wireless processor 103 may be different physical circuitry or all or a part of them may be same physical circuitry. The central processor 101 or a part of it (e.g., an execution controller 106) may be processing circuitry which implements functions achieved by the central processor 101 or the part of it.

The memory 102 is a memory configured with a volatile memory such as an SRAM or a DRAM, or a non-volatile memory such as an NAND and an MRAM. The memory 102 outputs a program or data in response to a read request from the central processor 101 (the transferor 109, the request executor 108, or the like) and stores a program or data inside in response to a write request from the central processor 101.

The wireless processor 103 is an interface which performs communication processing of a physical layer and a data link layer. Examples of the interface include a cellular communication technique such as LTE, CDMA, GSM and WiMAX, a wireless LAN interface complying with IEEE 802.11, or the like. The antenna 104 radiates an analog signal input from the wireless processor 103 to space as a radio wave. Further, the antenna 104 outputs an analog signal wirelessly received from space to the wireless processor 103. Further, the wireless processor 103 measures a parameter indicating a wireless communication environment such as a radio wave environment via the antenna 104. For example, the wireless processor 103 may measure received signal strength of a radio wave (received signal strength) transmitted from an access point, a noise emitted from another apparatus other than the access point, or the number of times of retry of frame transmission so far. Another apparatus other than the access point is not limited to a communication apparatus which is capable of communicating with the access point and may be an apparatus such as electric household appliance, which does not have a communication function. The wireless processor 103 may calculate an evaluation value which will be described later from the measured parameter value. The evaluation value may be calculated from the parameter value at the request executor 108. There is also a case where the parameter value itself can be the evaluation value.

The application executor 105 executes application (such as, for example, a web browser, news application, map application, a video player and a music player). The application executor 105 may execute the application in response to an instruction input via a user input interface. The application can be read out from, for example, an auxiliary storage apparatus (such as a hard disc, an SSD and an externally connected recording medium) which is not illustrated, decompressed at the memory 102 and executed. When it becomes necessary to transmit or receive data during execution of the application, the application executor 105 generates a communication request (a transmission request or a reception request) for requesting communication with another communication apparatus which becomes transmission destination or reception destination. The application executor 105 outputs the generated communication request to the transferor 109. Examples of the transmission request include data (transmission data) to be transmitted to a communication partner and information of destination. Examples of the reception request include information of destination.

While a case where the transmission request is generated as the communication request will be mainly described below, the reception request can be generated in a similar manner. After outputting the transmission request to the transferor 109, the application executor 105 may output an execution result request for requesting notification of an execution result (such as transmission success, transmission failed and during transmission) of the transmission request to the transferor 109 at an arbitrary timing such as after a certain period.

The network processor 107 performs processing of a communication protocol in a layer higher than the data link layer, and, for example, performs processing of a communication protocol such as TCP/IP and HTTP.

When acquiring a transmission request from the application executor 105, the transferor 109 stores the transmission request in the memory 102. When storing the transmission request is completed, the transferor 109 transmits an execution instruction notification for instructing the request executor 108 to execute the transmission request stored in the memory 102. When receiving the above-described execution result request from the application executor 105, the transferor 109 acquires an execution result of the transmission request from the memory 102 and returns the execution result to the application executor 105. In the case of the reception request, the transferor 109 also returns received data to the application executor 105. The received data may be returned to the application executor 105 separately from the execution result. For example, the received data may be read out from the memory 102 in response to a return request of the received data from the application executor 105.

Here, a timing at which the transmission result is returned to the application executor 105 can be various timings other than when the execution result request is received from the application executor 105. For example, the timing may be when execution of the transmission request stored in the memory 102 is completed, when a time out period set in advance has elapsed before execution of the transmission request is completed, or the like. Whether or not the time out period has elapsed may be measured through timer processing. While transmission data and information of the destination are included in the transmission request here, the transmission data and the information of the destination do not necessarily have to be included in the transmission request. For example, the transmission data or the information of the destination, or both of them may be stored in the memory 102, and information relating to an address at which these are stored is notified to the transferor 109, or included in the transmission request. The transferor 109 may access the memory 102 using the information relating to the address and read out the transmission data or the information of the destination or both of them from the memory 102.

When receiving the execution instruction notification from the transferor 109, the request executor 108 acquires a parameter indicating a radio wave environment between the information processing apparatus and a communication destination apparatus (here, assuming an access point) from the wireless processor 103. Measurement of the parameter at the wireless processor 103 may be performed in response to the instruction from the request executor 108 or may be performed, for example, every fixed time period, independently from the instruction. Specific examples of the parameter indicating the radio wave environment are as described above.

The request executor 108 calculates an evaluation value indicating the radio wave environment based on the acquired parameter. For example, the evaluation value may be a value obtained by converting a set of one or a plurality of parameter values into a value falling within a predetermined value range, or may be a parameter value itself if there is one parameter. An output value of a function which takes a plurality of parameters as input variables may be set as the evaluation value. The evaluation value may be calculated using other methods. The evaluation value may be calculated at the wireless processor 103 as described above.

The request executor 108 controls execution of the communication request corresponding to the execution instruction notification by comparing the evaluation value with a threshold of the radio wave environment. When the evaluation value exceeds the threshold, the request executor 108 determines that communication is feasible and executes the communication request. When the evaluation value is equal to or less than the threshold, the request executor 108 determines that communication is infeasible and stands by for execution of the communication request. As an example of execution of the communication request, when the communication request is a transmission request, the request executor 108 operates so as to start (or restart) data transmission to the communication destination apparatus through the network processor 107. When the communication request is a reception request, the request executor 108 operates so as to start (or restart) data reception through the network processor 107. After communication is started, communication may be continued regardless of the communication environment until execution of the communication request is completed, or, also after communication is started, the evaluation value may be compared with the threshold, and, if the evaluation value is equal to or less than the threshold, communication may be stopped. As one example, an upper limit value may be a value at the time when radio wave strength necessary and sufficient for communication can be obtained, and a lower limit value may be a value at the time when radio wave strength necessary and sufficient for communication cannot be obtained.

While the communication request is executed when the evaluation value exceeds the threshold here, there is also a case where the communication request is executed when the evaluation value falls below the threshold according to types of the evaluation value. Possible examples of this case include, for example, a case where the evaluation value correlates with a noise level.

Here, after receiving the execution instruction notification, the request executor 108 changes the threshold so as to decrease or increase according to a lapse of time. For example, the request executor 108 changes the threshold so as to monotonically decrease or monotonically increase over time. While the threshold is changed, for example, at fixed time interval, change of the threshold is not limited to this. In this manner, by changing the threshold according to a lapse of time, a criterion for allowing execution of the communication request becomes lax, so that it is possible to increase a possibility that the communication request is executed. By this means, it is possible to reduce a possibility that the communication request may not be executed indefinitely. Further, the lower limit value or the upper limit value may be set at the threshold, and when the threshold reaches the lower limit value or the upper limit value, the threshold may be fixed at the lower limit value or the upper limit value thereafter.

A limited period until completion of the execution may be set for the communication request. The limited period may be designated through user input, or designated by application, or fixedly determined in advance. Alternatively, the limited period may be determined according to types of data for which transmission or reception is requested in the communication request, or types of application which issues the communication request. The communication request indicates types of a file, types of a protocol header (such as HTTP), or the like. In the case of data transmission, types of the file or types of the protocol header may be included in the transmission data or the transmission request. In the case of data reception, types of the file or types of the protocol header may be included in the reception request.

If the limited period is set, the execution controller 106 performs processing of changing (decreasing or increasing) the threshold so that the threshold reaches the lower limit value or the upper limit value until the end time (deadline time) of the limited period. At this time, there are various possible methods for decreasing or increasing the threshold. For example, as illustrated in FIG. 2, the threshold is made to gradually decrease (for example, at a fixed rate). In the example of FIG. 2, the threshold is made to decrease stepwise in three stages. It is also possible to set more stages when the limited period from the start time to the end time is longer so that the threshold is finely changed. Alternatively, as illustrated in FIG. 3, the threshold may be maintained at a fixed value during a first period which is shorter than the limited period from the start time, and the threshold may be set at the lower limit value when the first period has elapsed.

The limited period may be determined at the request executor 108, or may be determined by the application executor 105 and included in the communication request, or notified to the communication executor using other methods. The limited period can be designated using other methods instead of designating a value of the limited period itself. For example, if the deadline time of completion of execution of the communication request is designated, a period from the current time (time at which the transferor 109 acquires the transmission request, time at which the execution instruction notification is received, or the like) until the deadline time may be set as the limited period. The deadline time may be determined by the application executor 105 and included in the communication request, or notified to the communication executor using other methods, or arbitrarily determined by the execution controller 106.

Operation of the communication apparatus will be described below. The operation of the communication apparatus mainly includes three phases, each of which will be described below.

### (First Phase)

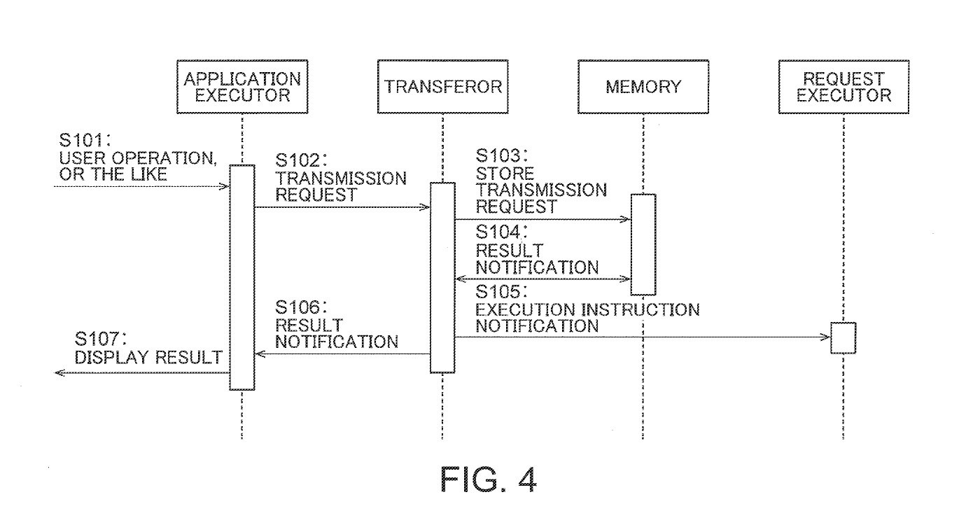

FIG. 4 illustrates an operation sequence of a first phase.

A transmission request is generated by application software executed at the application executor 105, triggered by user operation (S101), or the like. By this means, operation of the first phase is started. The generated transmission request is transmitted from the application executor 105 to the transferor 109 (S102). When receiving the transmission request, the transferor 109 requests the memory 102 to store the transmission request (S103), and the transferor 109 receives a result notification as to whether or not storing has been successful from the memory 102 (S104). When the storing has been successful, the transferor 109 transmits an execution instruction notification for instructing execution of the transmission request stored in the memory 102 (S105). Further, the transferor 109 returns a result notification as to whether or not the storing the transmission request in the memory 102 has been successful to the application executor 105 (S106). The application executor 105 displays content of the result notification on a screen of a display device (S107).

### (Second Phase)

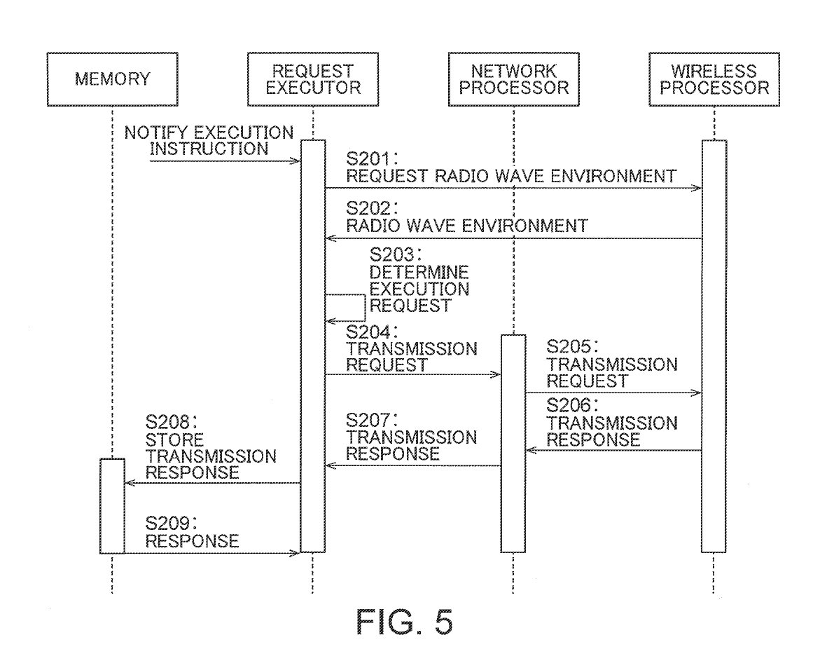

FIG. 5 illustrates an operation sequence of a second phase.

When the request executor 108 receives the above-described execution instruction notification of the transmission request, operation of the second phase is started. The request executor 108 periodically acquires a parameter of a radio wave environment from the wireless processor 103 and calculates an evaluation value (S201, S202). The evaluation value may be calculated at the wireless processor 103. The request executor 108 compares the evaluation value with a threshold, and, if the evaluation value exceeds the threshold, the request executor 108 determines execution of the transmission request (S203), and executes the transmission request. That is, the request executor 108 performs data transmission based on information of destination via the network processor 107 and the wireless processor 103 (S204, S205). If the evaluation value is equal to or less than the threshold, steps S201 and S202 are repeatedly performed. Further, at this time, the request executor 108 performs processing of changing the threshold (decreasing or increasing the threshold) according to a lapse of time. It should be noted that the request executor 108 may be put into a standby state, for example, a low power consumption state, before receiving the execution instruction notification, and may be recovered to a normal state when receiving the execution instruction notification.

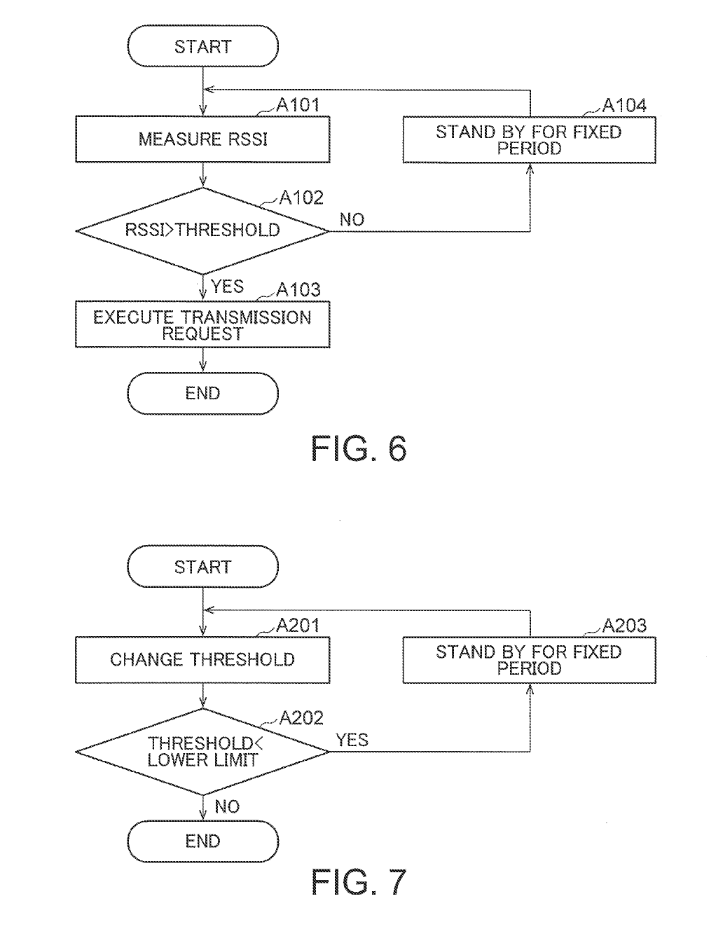

FIG. 6 illustrates a flowchart of operation of determination based on the evaluation value and the threshold. Here, an example where an RSSI is used as the evaluation value will be described. The wireless processor 103 is instructed to measure an RSSI, a measurement value of the RSSI is received (A101), and, if the measurement value of the RSSI is greater than the threshold (A102: Yes), the transmission request is executed (A103). If the measurement value of the RSSI is equal to or less than the threshold (A102: No), the request executor 108 stands by for a fixed period (A104), instructs the wireless processor 103 to measure the RSSI and receives the measurement value of the RSSI

FIG. 7 illustrates a flowchart of operation of changing the threshold. When a fixed period has elapsed after operation is started, the request executor 108 changes the threshold (for example, decreasing the threshold by a predetermined value) (A201), and decides whether the changed threshold is less than the lower limit value (A202). If the changed threshold is less than the lower limit value, the threshold is fixed at the lower limit value, and the processing is finished. If the changed threshold is equal to or greater than the lower limit value, the request executor 108 stands by for a fixed period (A203), and changes the threshold again (A201).

In FIG. 5, the request executor 108 receives a transmission result as to whether or not transmission of transmission data has been successful as a response via the wireless processor 103 and the network processor 107 (S206, S207). For example, the network processor 107 transmits the transmission data according to TCP/IP, and, if the network processor 107 recognizes that transmission of all the transmission data has been successful (S206), returns a transmission result of success to the request executor 108 (S207).

The request executor 108 requests the memory 102 to store the transmission result (S208), and, if storing has been successful, obtains a response indicating that the transmission result has been stored from the memory 102 (S209). When storing the transmission result is completed, processing of the request executor 108 is finished. The request executor 108 may transit to the above-described standby state as necessary. It should be noted that in the case of data reception, in place of the transmission result, a reception result as to whether or not reception has been successful and data received from the communication destination apparatus when reception has been successful are stored in the memory 102.

### (Third Phase)

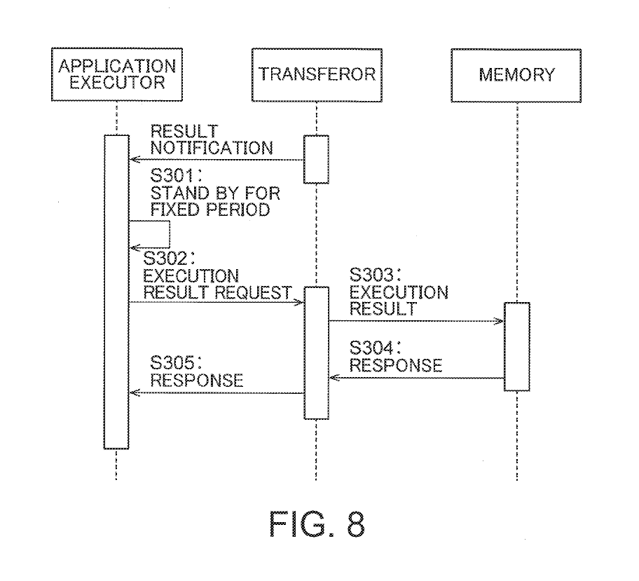

FIG. 8 illustrates an operation sequence of a third phase.

Operation of the third phase is started when the application executor 105 receives a result notification (S106 in FIG. 4) as to storing the transmission request in the memory 102 in the first phase. When receiving the result notification, the application executor 105 returns a response to application being running (whether or not storing the transmission request in the memory has been successful, that is, whether or not instruction of the transmission request has been successful). If storing the transmission request has been successful, then, the request executor 108 stands by for a fixed period (S301) and requests the transferor 109 to return an execution result of the transmission request (execution result request) (S302).

When receiving the execution result request from the application executor 105, the transferor 109 requests the memory 102 to return a response of the execution result (S303). If the execution is completed, the memory 102 returns the response of the execution result, and, if the execution is not completed yet, the memory 102 does not return the response of the execution result (S304). Alternatively, the memory 102 may return a response indicating that execution of the transmission request has not been completed yet. When the transferor 109 can receive the execution result from the memory 102, the transferor 109 returns the execution result to the application executor 105, and, if the transferor 109 cannot receive the execution result, the transferor 109 returns a response accordingly (such as a response indicating that execution of the transmission request has not been completed yet) (S305). It should be noted that the transmission request may be associated with the execution result by utilizing an arbitrary identifier or using other arbitrary methods. When an identifier is employed, for example, the identifier may be generated by utilizing a value included in the transmission request, or the identifier may be added to the transmission request itself by application.

Steps S301 to S305 are repeated until the execution result of the transmission request is returned to the application executor 105.

As described above, according to the first embodiment, by changing a threshold to be compared with an evaluation value according to a lapse of time after a communication request is generated, it is possible to reduce a possibility that the communication request may not be executed indefinitely. Further, according to the present embodiment, because the transmission request is executed when a radio wave environment is satisfactory by comparing the evaluation value with the threshold, it is possible to reduce energy consumption required for executing the transmission request. Still further, by changing the threshold to a lower limit value (or an upper limit value) until the end time of the limited period determined by a user, application or in advance, it is possible to increase a possibility that the transmission request is executable within the limited period.

### Second Embodiment

In the first embodiment, a circumstance has been assumed where there is only one transmission request and other transmission requests do not exist at the same time. On the other hand, in the present embodiment, a circumstance is assumed where a plurality of transmission requests exist at the same time in the application executor 105 (a circumstance where before one previous transmission request is completed, the next transmission request is generated, a circumstance where a plurality of transmission requests are generated by a plurality of applications in parallel at the same time, or the like).

A block diagram of a communication apparatus according to the second embodiment is the same as that in FIG. 1 according to the first embodiment. In the present embodiment, a function of the request executor 108 is expanded.

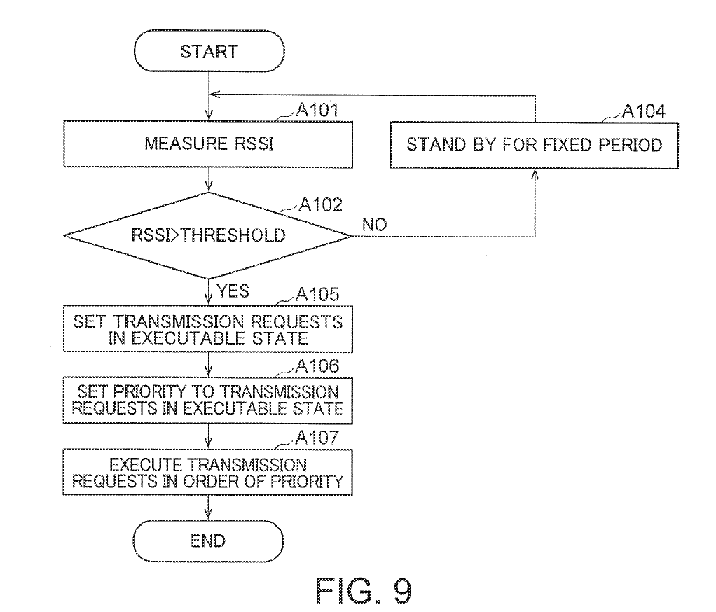

FIG. 9 illustrates a flowchart of one example of operation of determination based on the evaluation value and the threshold according to the second embodiment. Steps A101, A102 and A104 are the same as those in FIG. 6 according to the first embodiment. When receiving an execution instruction notification from the transferor 109, the request executor 108 acquires a measurement value of an RSSI from the wireless processor 103 (A101) and compare the measurement value of the RSSI with the threshold (A102). When the measurement value of the RSSI is equal to or less than the threshold (A102: No), the request executor 108 stands by for a fixed period (A104), and processing returns to step A101. When the RSSI exceeds the threshold (A102: Yes), a transmission request relating to the execution instruction notification is set in an executable state (A105). That is, in the present embodiment, even if the RSSI exceeds the threshold, the transmission request is not executed immediately. Setting of the executable state is performed by, for example, preparing a flag for each transmission request, and setting 1 for an executable state while setting 0 for a non-executable state. An initial value of the flag is set at 0.

When the RSSI (evaluation value) is equal to or less than the threshold, as with in the first embodiment, change of the threshold according to a lapse of time, acquisition of a parameter and calculation of an evaluation value, and comparison of the evaluation value with the threshold are repeated (see FIG. 7).

Here, comparison of the evaluation value with the threshold and change of the threshold may be performed for each of a plurality of transmission requests, or, a plurality of transmission requests may be grouped and comparison of the evaluation value with the threshold and change of the threshold may be performed for each group, and determination as to whether or not communication is feasible may be performed for each group. While an arbitrary grouping method can be employed, transmission requests having the same communication destination may be grouped into the same group, or transmission requests generated for each given period may be grouped into the same group.

The request executor 108 specifies transmission requests in an executable state and determines an execution order of the transmission requests (A106). That is, the request executor 108 determines priority of execution of the transmission requests. Then, the request executor 108 executes the transmission requests in the determined order (A107). The execution order or the priority may be determined using an arbitrary method, and, for example, may be determined from an order in which the transmission requests are generated, transmission data sizes, destination of data, a simultaneously transmission maximum number of transmission requests, or the like. The simultaneously transmission maximum number of communication requests is the allowable number of transmission requests which can be simultaneously (in parallel) executed. The simultaneously transmission maximum number of transmission requests may be changed according to a value of the evaluation value (change of a radio wave environment). When a transmission request in an executable state is additionally generated, the execution order may be re-scheduled. Further, the execution order of the transmission requests may be determined for each of the above-described group, and simultaneous execution of the transmission requests may be allowed among groups. That is, execution of the transmission requests may be independent among the groups. Further, sequential execution of the transmission requests means that when the simultaneously transmission maximum number of transmission requests is 1, the next transmission request is not executed until one transmission request is completed.

While in the present embodiment, a case has been described where a plurality of communication requests are all transmission requests, the same also applies to a case where a plurality of communication requests are all reception requests. Further, the same also applies to a case where these communication requests are transmission requests and reception requests.

As described above, according to the second embodiment, even if a plurality of transmission requests are generated and put into an executable state, by controlling an execution order (for example, by determining priority), it is possible to prevent a large number of transmission requests from being started at the same time, thereby it is possible to improve execution efficiency of the respective transmission requests. If all of these plurality of transmission requests are executed at the same time, there is a possibility that it may take time to execute the respective transmission requests due to parallel processing. Meanwhile, by sequentially executing the transmission requests, it can be expected that execution of transmission requests which are executed earlier is completed earlier. Further, according to the present embodiment, even if the radio wave environment unexpectedly changes, by changing the simultaneously transmission maximum number of transmission requests, it is possible to realize efficient transmission.

### Third Embodiment

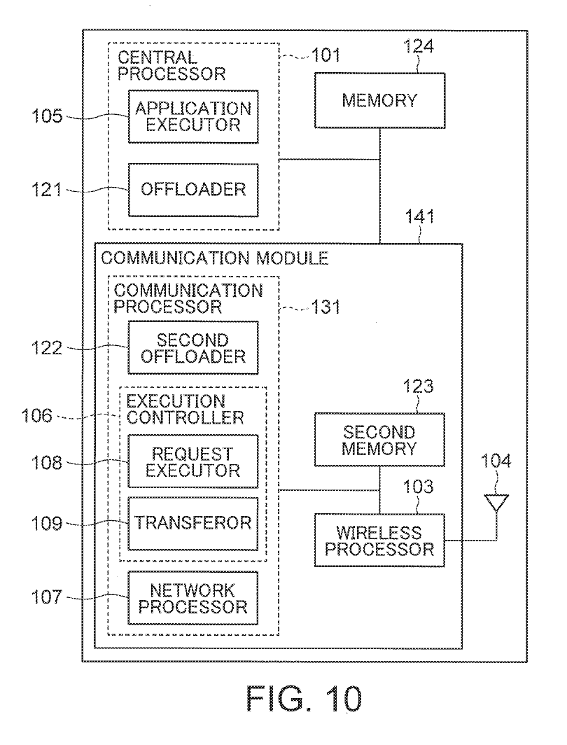

FIG. 10 illustrates a communication apparatus provided with an information processing apparatus according to a third embodiment. In the present embodiment, a communication module 141 is implemented within the communication apparatus. An execution controller 106 (the request executor 108, the transferor 109) which implements main functions of the first or the second embodiment is provided at the communication module 141. Power supply to the central processor 101, the memory 124 and the communication module 141 is individually controlled, and if the operation is not necessary, a state may be made to transit to a low power consumption state by turning off or reducing power supply.

The central processor 101, the memory 124 and the communication module 141 are connected via a bus.

The central processor 101 includes the application executor 105 and an offloader 121.

The communication module 141 includes a communication processor 131, a second memory 123, the wireless processor 103 and the antenna 104. The communication processor 131 includes a second offloader 122, the execution controller 106 (the request executor 108 and the transferor 109), and the network processor 107. The communication module 141 or the communication processor 131 corresponds to the information processing apparatus according to the present embodiment. A role of the memory described in the first or the second embodiment is taken by the second memory 123 in the present embodiment.

The central processor 101, the wireless processor 103 and the communication processor 131 can be implemented by circuitry such as a processor or an integrated circuit. Each circuitry which implements the central processor 101, the wireless processor 103 and the communication processor 131 may be different physical circuitry or all or a part of them may be same physical circuitry. The central processor 101, the communication processor 131 or a part of them (e.g., an execution controller 106) may be processing circuitry which implements functions achieved by the central processor 101, the communication processor 131 or a part of them.

The offloader 121 of the central processor 101 performs processing of offloadering processing after a communication request (transmission request, reception request) is generated by application executed by the application executor 105, to the communication module 141. For example, when communication application for acquiring information using HTTP, such as a web browser and an RSS reader is run at the application executor 105, processing of the communication protocol associated with acquisition or communication itself using TCP/IP can be offloadered to the communication module. In order to execute such offloadering, the application executor 105 notifies an acquisition request of the above-described information to the offloader 121. The offloader 121 offloaders processing of the application or communication processing (such as HTTP and TCP/IP) according to a format determined in advance between the offloader 121 and the second offloader 122.

The second offloader 122 receives a notification from the offloader 121 and provides an instruction to the execution controller 106 and the second network processor 107 according to the notification. The operation thereafter is the same as that in the first or the second embodiment. It should be noted that an advance acquisition function may be provided within the communication processor 131. With the advance acquisition function, if a request is a request (reception) for acquiring information using HTTP, a link (such as an URL) included in data received according to the acquisition request of the information is specified, and an acquisition request of the information is autonomously generated from link destination (without an instruction being received from the central processor 101) and data is received. The received data is stored in the second memory 123 or the memory 124. If data of the link destination is requested from the central processor 101 afterward, the data is read out from the second memory 123 or the memory 124 and transferred.

The communication module 141 measures a radio wave environment, executes evaluation and a transmission request, or the like, independently from the central processor 101. Therefore, during that time, the central processor 101 and the memory 124 can transit to a low energy consumption state. When receiving a result notification (see FIG. 8) from the transferor 109, the central processor 101 may be recovered from the low energy consumption state when transmitting an execution result request to the transferor 109. It should be noted that the central processor 101 and the memory 124 may be recovered from the low energy consumption state automatically through timer processing, or by a command from the communication module 141.

It should be noted that while in FIG. 10, the network processor 107 is disposed at the communication module 141 side, it is also possible to respectively dispose the first and the second network processors at the central processor 101 and the communication module 141 instead and divide a function of the network processor 107 between the first and the second network processors. Processing of the first network processor may functionally overlap with processing of the second network processor, in which case processing executed at the first network processor does not have to be performed at the second network processor. When the central processor 101 is made to transit to the low power consumption state, the first network processor may be maintained in a normal operation state.

As described above, according to the third embodiment, by shifting part of the function of the central processor to the communication module, it is possible to reduce load on the central processor. Further, while the function is executed at the communication module, by putting the central processor into a low power consumption state, it is possible to reduce power consumption of the central processor.

### Fourth Embodiment

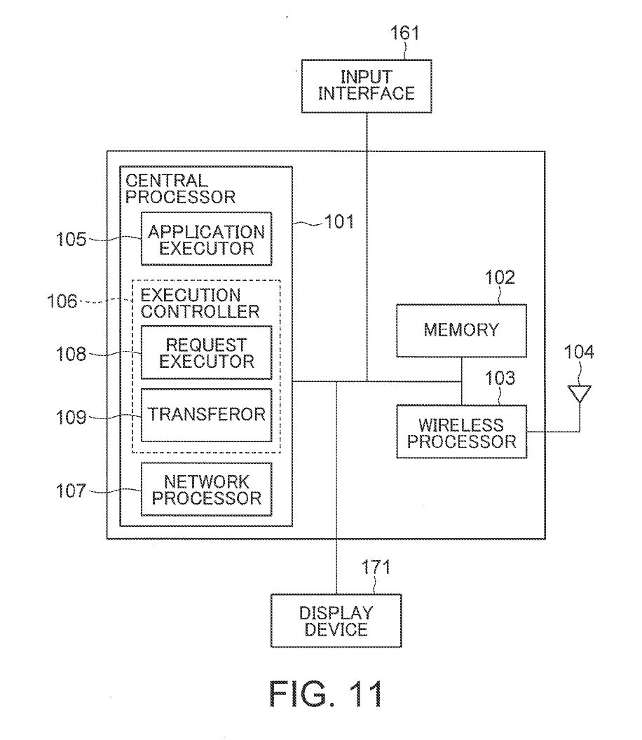

FIG. 11 illustrates a terminal on which an information processing apparatus according to a fourth embodiment is mounted. In this terminal, an input interface 161 and a display device 171 are added to the communication apparatus according to the first embodiment. The input interface 161 which is an interface for user input, includes a keyboard, a mouse, a touch panel, or the like. The display device 171 displays data stored in the memory 124 as an image. Any apparatus which can display an image, such as, for example, a liquid crystal display panel, a CRT panel, an organic EL panel and an electronic paper, can be used as the display device 171. In addition, an auxiliary storage apparatus such as a hard disc and an SSD may be additionally connected. The terminal in FIG. 11 may be an arbitrary apparatus provided with a communication function, such as a personal computer (PC), a laptop PC, a tablet terminal, a smartphone, a wearable apparatus and a camera. It is also possible to configure a terminal in a similar manner in the second and the third embodiments by adding an input interface and a display device.

The information processing device, the communication apparatus and the terminal as described above may also be realized using a general-purpose computer device as basic hardware. That is, each function block (or each section) in the information processing device, the communication apparatus and the terminal can be realized by causing a processor mounted in the above general-purpose computer device to execute a program. In this case, the information processing device, the communication apparatus and the terminal may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

The terms used in each embodiment should be interpreted broadly. For example, the term “processor” may encompass a general purpose processor, a central processor (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electronically communicates with a processor if the processor read and/or write information for the memory. The memory may be integrated to a processor and also in this case, it can be said that the memory electronically communication with the processor.

The term “storage” may generally encompass any device which can memorize data permanently by utilizing magnetic technology, optical technology or non-volatile memory such as an HDD, an optical disc or SSD.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus comprising:
processing circuitry to acquire a communication request for requesting data communication with another communication apparatus and to control execution of the communication request by comparing an evaluation value with a threshold, the evaluation value being based on a parameter value obtained through measurement of a wireless communication environment,
wherein the processing circuitry changes the threshold so as to decrease or increase according to a lapse of time after acquiring the communication request.

2. The apparatus according to claim 1, wherein the processing circuitry executes the communication request when the evaluation value exceeds the threshold when the threshold is decreased, or when the evaluation value falls below the threshold when the threshold is increased.

3. The apparatus according to claim 1, wherein the processing circuitry decreases the threshold to a lower limit value in a case of decreasing the threshold, or increases the threshold to an upper limit value in a case of increasing the threshold.

4. The apparatus according to claim 3, wherein
the communication request requires that execution is completed within a limited period, and
the processing circuitry decreases the threshold to the lower limit value before the limited period ends in the case of decreasing the threshold, or increases the threshold to the upper limit value before the limited period ends in the case of increasing the threshold.

5. The apparatus according to claim 4, wherein the processing circuitry gradually decreases or increases the threshold.

6. The apparatus according to claim 3, wherein the processing circuitry maintains the threshold at a fixed value during a first period, the first period being shorter than the limited period, and changes the threshold to the lower limit value or the upper limit value after a lapse of the first period.

7. The apparatus according to claim 4, wherein the limited period is determined according to types of data for which transmission or reception is requested in the communication request, or types of application which issues the communication request.

8. The apparatus according to claim 4, wherein
deadline time for completion of execution of the communication request is previously designated, and
the limited period is a period from time at which the processing circuitry acquires the communication request until the deadline time.

9. The apparatus according to claim 1, wherein the processing circuitry acquires a plurality of the communication requests, groups the plurality of communication requests, determines whether communication is feasible or infeasible by comparing the evaluation value with the threshold for each group, and sequentially executes the communication requests belonging to a group for which communication is allowed.

10. The apparatus according to claim 9, wherein the processing circuitry sets priority to the plurality of communication requests and executes the plurality of communication requests in order of the priority.

11. The apparatus according to claim 1, wherein
the processing circuitry generates the communication request by executing an application, and
the execution controller acquires the communication request from the application executor.

12. A communication apparatus comprising:
the information processing apparatus according to claim 1; and
a wireless processor to perform wireless communication according to the communication request executed by the information processing apparatus.

13. A terminal comprising:
the information processing apparatus according to claim 1;
a wireless processor to perform wireless communication according to the communication request executed by the information processing apparatus;
a memory to store data transmitted or received in the data communication;
an input interface for user input to provide an instruction to the information processing apparatus; and
a display device to display data in the memory.

14. A communication processing method performed by a computer, comprising:
acquiring a communication request for requesting data communication with another communication apparatus;
controlling execution of the communication request by comparing an evaluation value with a threshold, the evaluation value being based on a parameter value obtained through measurement of a wireless communication environment,
changing the threshold so as to decrease or increase according to a lapse of time after acquiring the communication request.

15. A non-transitory computer readable medium having a computer program stored therein which causes a computer when executed by the computer, perform processes comprising:
acquiring a communication request for requesting data communication with another communication apparatus;
controlling execution of the communication request by comparing an evaluation value with a threshold, the evaluation value being based on a parameter value obtained through measurement of a wireless communication environment,
changing the threshold so as to decrease or increase according to a lapse of time after acquiring the communication request.
